(19) United States
(12) Patent Application Publication
(10) Pub. No.: US 2010/0064048 A1
(43) Pub. Date: Mar. 11, 2010

(54) FIRMWARE/SOFTWARE VALIDATION

(76) Inventor: Stuart A. Hoggan, Longmont, CO (US)

Correspondence Address: DAVIS WRIGHT TREMAINE LLP - San Francisco, 505 MONTGOMERY STREET, SUITE 800, SAN FRANCISCO, CA, 94111, US

(21) Appl. No.: 12/205,706

(22) Filed: Sep. 5, 2008

(51) Int. Cl. G06F 15/173

(52) U.S. Cl. 709/229

(57) ABSTRACT

The fingerprint value of the firmware or software of a client device is received and the validity of the fingerprint is verified. Network access control device is notified when the fingerprint of the firmware or software from the client device is determined to be not authorized.

### BACKGROUND OF INVENTION

This invention relates in general to firmware or software validation and in particular validation of firmware or software used for accessing media content.

One popular method for gaining unauthorized access to media content delivered through the internet is to replace the firmware or software in devices used for accessing the content through the internet, such as that in cable modems. This may be typically done by finding development/diagnostic back-doors or replacing/reprogramming non-volatile memory chips that store the firmware or software image. While secure methods of downloading the firmware, such as those from multi-system operators (“MSOs”), are available for remote provisioning, the integrity of the firmware or software usually is not checked after the installation. It is then possible for hackers to replace the firmware installed with unauthorized code, thereby enabling the hacker to steal cable service or other types of media service.

Other types of media content delivery systems may face the same threat. For example, hackers may also be able to replace the firmware or software in devices used for accessing media content from internet protocol television (IPTV) systems, or still other types of media delivery systems. It is therefore desirable to provide a solution whereby such fraudulent access can be prevented or reduced.

### SUMMARY OF THE INVENTION

According to one embodiment of the invention, the value of a fingerprint of the firmware or software in a client device is received, and the validity of the fingerprint is verified. Where access of the client device to a network is controlled by a network access control device, the network access control device is notified when the fingerprint of the firmware or software from the client device is determined to be not authorized.

In another embodiment of the invention, a client device provides the value of a fingerprint of the firmware or software to a requester. Preferably, the value of the fingerprint is provided using a hash algorithm.

In yet another embodiment of the invention, a system for validating firmware or software at a client device accessing a network comprises a validation server. The validation server includes a fingerprint database for verifying whether a fingerprint of the firmware or software of the client device is authorized. The system further includes a network access control device. When the validation server determines that the fingerprint of the client device is not authorized, the validation server will send a message to the network access control device. The network access control device controls access to the network by the client device in response to the message from the validation server.

The above features may be used individually or in combination.

All patents, patent applications, articles, books, specifications, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

### BRIEF DESCRIPTION OF THE DRAWINGS

FIG. 1 is a system flow diagram of an operation for the validation of firmware or software in a client device to illustrate an embodiment of the invention.

FIG. 2 is a flow chart depicting a process at a firmware validation server to illustrate one embodiment of the invention.

FIG. 3 is a flow diagram of a process for generating a digitally signed fingerprint response message at the client device to illustrate one embodiment of the invention.

FIG. 4 is a schematic view of the certificates at the client device.

FIG. 5 is a schematic view of the components of the client device including a secure processor and a protective memory for illustrating one embodiment of the invention.

For simplicity in description, identical components are labeled by the same numerals in this application.

### DETAILED DESCRIPTION OF EXEMPLARY EMBODIMENTS

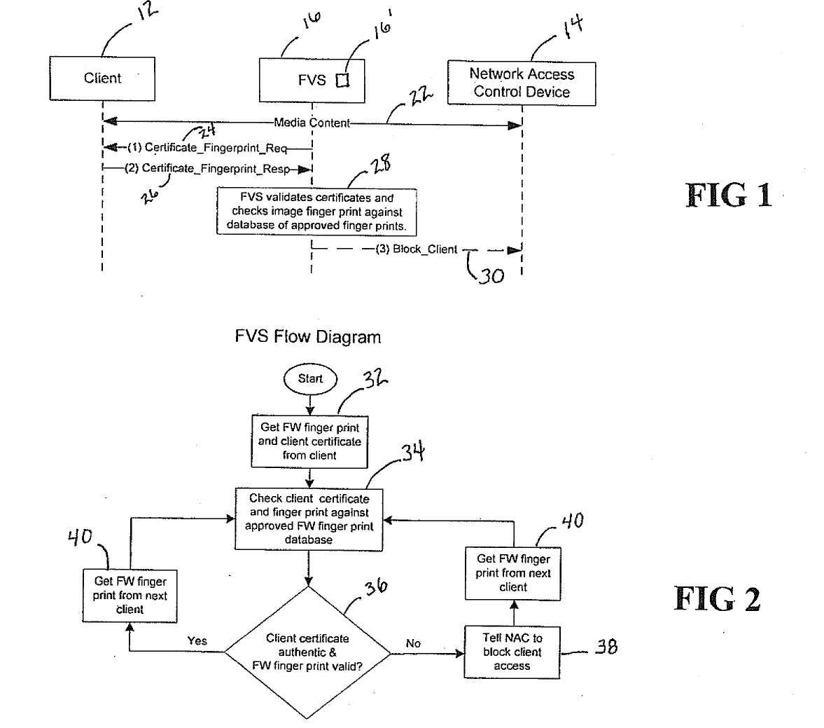

In reference to FIG. 1, access to media content 22 on a network (not shown) by device 12 is controlled by a network access control device 14. The network is preferably bidirectional and preferably includes a coaxial cable, internet, phone modem or satellite communication. In one embodiment, the media content is provided through an internet protocol (IP) network. In such embodiment, the network access control device 14 may be or includes a dynamic host configuration protocol (DHCP) server. In an IP network, client devices are able to gain access to the network only when they have properly assigned IP addresses which are assigned by the DHCP server. If a client device does not have a proper IP address, or has its IP address revoked by DHCP server, the client device will not be able to gain access to the network or any content provided through the network. In this manner, the DHCP controls access to the network. A firmware/software validation server (FVS) 16 on the network, such as an IP network, is for validating firmware or software in client device 12. The network access control device 12 can also be or include a cable modem termination server, a call management server or a router/gateway.

In one embodiment, FVS 16 sends a request to client device 12 for a client certificate and fingerprint of the firmware/software as indicated by arrow 24. Alternatively, client device 12 may send client certificate and fingerprint of the firmware/software periodically to FVS 16, without being requested by FVS 16. FVS 16 contains a database 16′ of approved fingerprints. The approved fingerprints may be first obtained from the network owner or operator. Where the network is owned or operated by a MSO, the MSO may work with vendors to obtain these approved fingerprint values or can obtain them during pre-deployment testing of cable modems, using hashing functions to convert an image of legitimate firmware/software to fingerprint values, for example. As described in more detail below, a nonce value may preferably be used to reduce the likelihood or replay attacks in some embodiments. Where a nonce value is used, FVS 16 then validates the certificate of the client device received from the client device, checks the digital signature, checks the updated nonce value and also checks the fingerprint value received from the client device against the approved fingerprint values in the database 16′. If the certificate of the client device is not a valid certificate, the updated nonce is not the expect value, or the fingerprint received from the client device does not match any one of the approved fingerprint values in the database 16′, FVS 16 will notify the network access client device 14 so that device 14 can choose to block the client device 12 from accessing the media content on the network.

Where the media content is provided by IPTV, a database 16′ may contain valid firmware or software fingerprint values that are allowed on the IPTV network. Media content is provided on the IPTV network by an IPTV operator. FVS 16 may then periodically check the firmware fingerprint values of client devices that are online. In this embodiment, the FVS 16 may send periodic requests to client devices that have current access to the network. Alternatively, the protocol of the network can be such that client devices are required to send to the FVS 16 periodically, their certificates and the fingerprint values of the software/firmware therein. A nonce value may also be preferably used to reduce the likelihood of replay attacks on the IPTV network in some embodiments.

The process carried out by FVS 16 for validating the client device 12 is illustrated in more detail in FIG. 2. In reference to FIG. 2, FVS 16 receives the firmware/software fingerprint and client certificate from the client device 12 (Block 32). The FVS 16 then verifies the authenticity of the client certificate, checks the updated nonce value, and compares the fingerprint from the client device to the list of approved fingerprint values in its database 16′ (Block 34). The method of updating the nonce can be agreed upon beforehand, so that FVS 16 is able to verify the validity of the updated nonce.

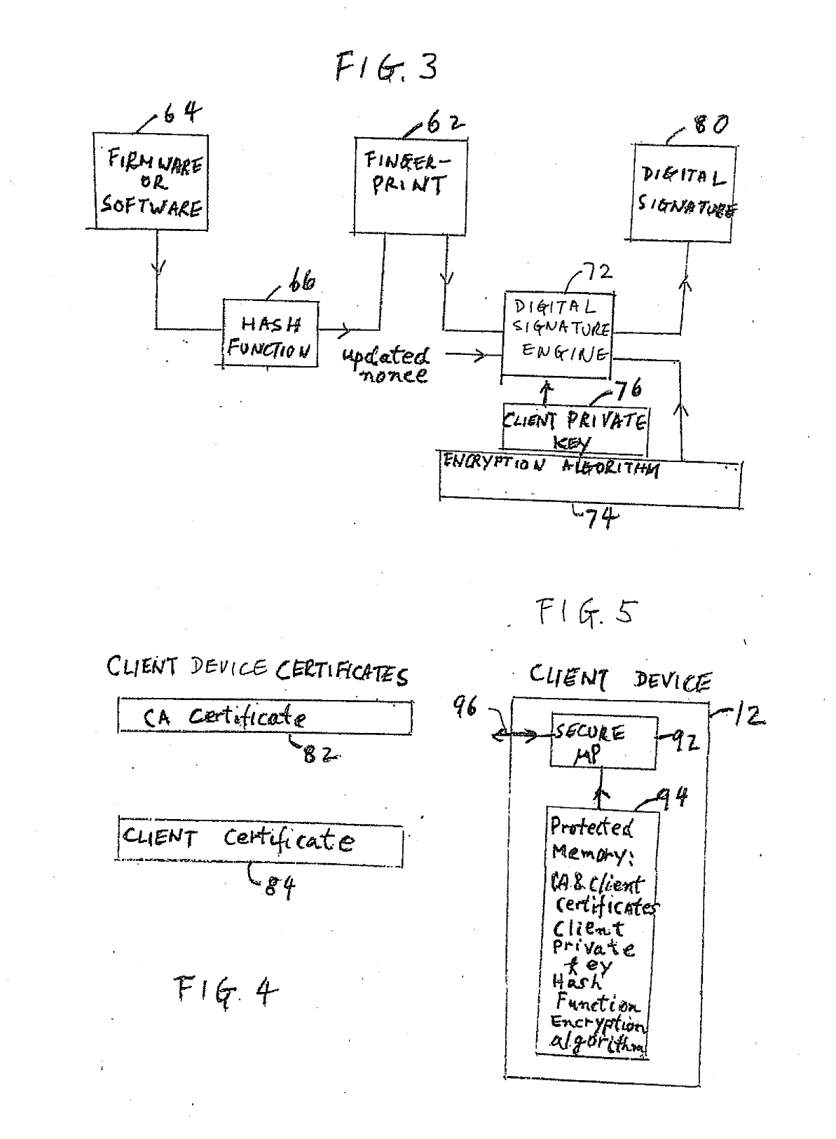

If the client certificate is not authentic, the updated nonce is not the expected value, or if the device firmware or software fingerprint value is not valid, FVS 16 will notify the network access control device 14 so that access of the client device to the network can be blocked (Diamond 36, Block 38). In either case, FVS 16 then proceeds to obtain the firmware/software fingerprint value from the next client device on the network and repeats this checking process in Block 34 until it has checked the client certificates and firmware or software fingerprint values of all client devices on the network (Block 40). Client device 12 obtains the firmware/software fingerprint value 62 by means of a hashing function 66 operating on the firmware/software 64 as shown in FIG. 3.

To prevent or reduce the chances of replay attacks, preferably FVS 16 sends a nonce along with its request for a certificate and fingerprint value to client device 12 indicated by arrow 24. Client device 12 provides an updated value of the nonce to FVS 16 in response thereto. FIG. 3 is a flow diagram of a process carried out by the client device 12 to illustrate one embodiment of the invention. As shown in FIG. 3, the client device 12 obtains a fingerprint 62 from the firmware or software 64 stored therein by means of a hash function 66. In embodiments where the request from FVS 16 includes a nonce, client device 12 updates the nonce, by a method that is known beforehand (e.g. agreed to beforehand as arranged by the MSO or IPTV network operator) to the FVS 16, such as by adding a value to the nonce. The updated nonce is an additional input to the Digital Signature Engine 72 that operates on the updated nonce and the fingerprint 62 to provide a digital signature 80 which is then a function of both the updated nonce and the fingerprint value 62 of the firmware or software image 64. The digital signature 80 is returned by the client device 12 along with the updated nonce value and fingerprint 62 to FVS 16 as indicated by arrow 26 in FIG. 1.

FIG. 4 is a schematic view illustrating the certificates in client device 12. As shown in FIG. 4, the client device 12 contains a certificate of the certificate authority (CA) and its own certificate 84. Thus when the client device 12 responds to FVS 16 request as indicated by arrow 26, the client device sends the client certificate 84, digital signature 80, updated nonce value, as well as the fingerprint 62 to FVS 16.

FIG. 5 is a schematic view illustrating some of the components of client device 12. As shown in FIG. 5, client device 12 includes a secure microprocessor 92 and a protected memory 94 which stores therein the two certificates 82, 84, hash function 66, the private key 76 and encryption algorithm 74. Protected memory 94 is protected in a known manner so that if it is tampered with, the contents of the memory will be erased or destroyed, or the memory becomes inoperative. Secure microprocessor 92 is protected in a known manner so that if it is tampered with, it becomes inoperative. Secure microprocessor 92 prevents access to the protected memory 94 in a known manner. The firmware or software 64 is also stored in the client device 12, but not necessarily in the protected memory 94. To perform the operations illustrated in FIG. 3, processor 92 fetches, from memory 94, the hash function 66, encryption algorithms 74 and private key 76 and performs the operations of FIG. 3, including the operations of hashing function 66 and Digital Signature Engine 72. Processor 92 then fetches, from memory 94, the client certificate 84, and provides the digital signature 80 along I/O lines 96 for transmission to FVS 16, along with the client certificate 84, the updated nonce value, and the fingerprint 62.

As shown in FIG. 1, FVS 16 receives the digital signature 80, certificate 84, the updated nonce value, and fingerprint 62 from client device 12 as indicated by arrow 26. FVS 16 verifies the authenticity of the client certificate 84 and checks the digital signature. If the client certificate and the digital signature are valid it checks to determine that the updated nonce value is correct and that the fingerprint value matches a fingerprint value in its approved database. This is explained in detail below.

FVS 16 first checks the authenticity of the client certificate 84, using the CA public key in its possession. If the client certificate 84 is not authentic, FVS will notify network access control device 14. In one embodiment, FVS 16 has access to a digital signature validation algorithm that is used to verify the digital signature sent by the client device. If the client certificate 84 has been verified to be authentic, FVS 16 then checks whether the digital signature is valid. If the digital signature is valid, FVS 16 then checks if the updated nonce value is correct. If the updated nonce value is correct the FVS 16 checks if the fingerprint received from the client device matches a fingerprint in the approved database. If there is a match the firmware or software 64 running on the client device is considered valid.

As noted above, where FVS 16 determines that the fingerprint value 62 of firmware or software 64 of client device 12 is not on the approved list of fingerprint values, it then notifies the network access control device 14, such as by sending a “Block client” message as indicated by arrow 30. Client device 14 may then take appropriate action, including the action of blocking access to the network by the client device 12.

Alternatively, where no client certificate 84 is checked by FVS 16 for authenticity, there is no need for device 12 to send any certificate or digital signature to FVS 16, and the FVS 16 will simply compare the fingerprint 62 to the approved fingerprints in database 16′ to determine whether firmware or software 64 is genuine or fraudulent.

While the invention has been described above by reference to various embodiments, it will be understood that changes and modifications may be made without departing from the scope of the invention, which is to be defined only by the appended claims and their equivalents.

1. A method for validating firmware or software at a client device that can access a network controlled by a network access control device, comprising:
receiving from the client device a value of a fingerprint of the firmware or software;
verifying validity of the fingerprint of the firmware or software received from the client device; and
notifying the network access control device when the fingerprint of the firmware or software from the client device is not authorized.

2. The method of claim 1, wherein the method is performed by a validation server.

3. The method of claim 2, wherein the validation server includes a fingerprint database, wherein said verifying includes comparing said fingerprint of the firmware or software from the client device with fingerprints in the fingerprint database.

4. The method of claim 1, wherein the network access control device blocks access to the network by the client device, when the network access control device is notified that the fingerprint of the firmware or software from the client device is not authorized.

5. The method of claim 1, wherein the network provides media content, so that the network access control device blocks access by the client device to the media content provided by the network, when the network access control device is notified that the fingerprint of the firmware or software from the client device is not authorized.

6. The method of claim 1, wherein the fingerprint of the firmware or software is derived from the firmware or software by means of a hash function.

7. The method of claim 1, further comprising sending the client device a request for the fingerprint of the firmware or software.

8. The method of claim 7, wherein the request to the client device includes a request for a device certificate of the client device certified by a certificate authority.

9. The method of claim 8, further comprising verifying authenticity of the device certificate of the client device.

10. The method of claim 7, wherein the sending of the request to the client device includes sending a nonce, and the receiving receives a digitally signed response that is a function of an updated value of the nonce.

11. A method for validating firmware or software at a client device that can access a network controlled by a network access control device, comprising:
the client device receiving from a server a request for a fingerprint value of the firmware or software; and
the client device providing a value of a fingerprint of the firmware or software using a hash algorithm.

12. The method of claim 11, wherein the request to the client device includes a request for a device certificate of the client device certified by a certificate authority.

13. The method of claim 12, further comprising verifying authenticity of the device certificate of the client device.

14. The method of claim 11, wherein the request to the client device includes a nonce, the client device providing a digitally signed response that is a function of an updated value of the nonce.

15. A system for validating firmware or software at a client device that can access a network, comprising:
a validation server, said server including a fingerprint database for verifying whether a fingerprint of the firmware or software at the client device is authorized; and
a network access control device, said validation server sending a message to the network access control device when the fingerprint of the client device is not authorized, said network access control device controlling access to the network by the client device in response to the message from the validation server.

16. The system of claim 15, further comprising said client device, said client device comprising a secure processor, said secure processor comprising a protected memory that stores an algorithm and a private key of the client device used to calculate respectively the fingerprint and a digital signature of said firmware or software.

17. The system of claim 16, said secure processor preventing access to said protected memory.

18. The system of claim 16, wherein physically tampering with said protected memory causes memory to be erased/destroyed.

19. The system of claim 16, said fingerprint of the firmware or software being derived from the firmware or software by means of said algorithm which includes a hash function.

20. The system of claim 15, at least one of said validation server and said network access control device communicating with said client device by means of a bidirectional network.

21. The system of claim 20, said bidirectional network including a coaxial cable, internet, phone modem or satellite communication.

22. The system of claim 15, said network access control device controlling access to the network by the client device in response to the message from the validation server by blocking access by said client device to the network.

23. The system of claim 15, said network access control device including a cable modem termination server, a DHCP server, a call management server or a router/gateway.
